(19) United States
(12) Patent Application Publication
(10) Pub. No.: US 2015/0315971 A1
(43) Pub. Date: Nov. 5, 2015

(54) HIGH-SPEED VEHICLE POWER AND THERMAL MANAGEMENT SYSTEM AND METHODS OF USE THEREFOR

(71) Applicant: Government of the United States as Represented by the Secretary of the Air Force, Wright-Patterson AFB, OH (US)

(72) Inventors: Thomas L. Reitz, Centerville, OH (US); Larry Byrd, Huber Heights, OH (US)

(73) Assignee: Government of the United States as Represented by the Secretary of the Air Force, Wright-Patterson AFB, OH (US)

(21) Appl. No.: 14/519,872

(22) Filed: Oct. 21, 2014

Related U.S. Application Data
(60) Provisional application No. 61/893,365, filed on Oct. 21, 2013.

(51) Int. Cl. F02C 7/224; B64D 33/08; B64C 30/00

(52) U.S. Cl. CPC F02C 7/224; B64C 30/00; B64D 33/08; F05D 2220/323

(57) ABSTRACT

A thermal management and power generation system for a hypersonic vehicle. The thermal management and power generation system comprising a fluid supply having a volatile fluid and a fuel supply having an endothermic fuel. A first heat exchanger, fluidically coupled to the fluid supply, absorbs heat from a first portion of the hypersonic vehicle, which vaporizes the volatile fluid. A mixing apparatus, fluidically coupled to the first heat exchanger and the fuel supply combines the vaporized volatile fuel and endothermic fuel. A second heat exchanger, fluidically coupled to the mixing apparatus, absorbs heat from a second portion of the hypersonic vehicle and decomposes the endothermic fuel by endothermic pyrolysis. A heat engine, fluidically coupled to the first heat exchanger and the mixing apparatus, is configured to generate an electrical power for use by the hypersonic vehicle. The vaporized volatile fluid mixed with the endothermic fuel within the second heat exchanger reduces coking caused by the endothermic pyrolytic decomposition of the endothermic fuel as compared to an endothermic pyrolytic decomposition of an endothermic fuel not having a vaporized volatile fluid mixed therewith.

Pursuant to 37 C.F.R. §1.78(a)(4), this application claims the benefit of and priority to prior filed, co-pending Provisional Application No. 61/893,365, filed 21 Oct. 2013 (pending), the disclosure of which is incorporated herein by reference, in its entirety.

### RIGHTS OF THE GOVERNMENT

The invention(s) described herein may be manufactured and used by or for the Government of the United States for all governmental purposes without the payment of any royalty.

### FIELD OF THE INVENTION

The present invention relates generally to thermal management and power generation for hypersonic vehicles and, more particularly to systems and methods of thermal management and for management and generation of power for hypersonic vehicles.

### BACKGROUND OF THE INVENTION

High supersonic and hypersonic vehicles encounter (1) extremely challenging atmospheres that are characterized by fluctuating aerodynamic, thermal, and pressure loads and (2) a destructive environment comprising combustion products and oxygen. Stagnation temperatures of the environment can exceed 2700° F., which creates enormous platform aerodynamic and engine system heating loads that must be actively managed. Additional vehicle heating can be caused by low quality heat sources, such as, electronic systems and sub-systems heating, including the avionics system and other onboard electronic and hydraulic systems. One conventional approach to managing these heat loads is the use of endothermic fuels. Cryogenic fuels (for example, liquid hydrogen), are a subset of endothermic fuels and provide a heat sink for transfer of heat. However, for flights lasting longer than a few minutes, the heat loads are such that the sensible energy capacity of the cryogenic fuel is insufficient to provide platform-level cooling.

To improve cooling, the fuel, which is often a specially formulated hydrocarbon, is decomposed within a heat exchanger via catalytically or non-selective mechanisms. The resultant endothermic energy of the fuel pyrolysis can significantly extend the cooling capacity of the vehicle's fuel thermal management system. The heat load transferred from the vehicle to the fuel is then re-injected into the engine wherein it is exhausted out the vehicle effluent. Still, the heat loads generated during flight often exceed the capacity of these conventional endothermic fuel cooling systems.

Endothermic decomposition of fuel, as a means for high-speed vehicle thermal management, has been extensively studied. Yet significant problems remain. While endothermic pyrolysis reactions break hydrocarbon fuels down into lighter species that can be more favorable in terms of ignition delay, coking of the heat exchanger channels due to nonselective carbon deposition remains a considerable challenge. This spontaneous carbon deposition can dramatically restrict mission duration, and ultimately success, due to clogging and closure of the passages within the fuel system and heat exchanger. In addition, these deposits reduce heat transfer and may create hot spots within the passages. Conventional strategies for reducing the rate of carbon deposition include fuel deoxygenation, incorporation of homogeneous or heterogeneous catalysts, incorporation of fuel additives, the use of lubricants, or combinations thereof. While each of these approaches has demonstrated some measure of success in reducing carbon deposition rates, the addition of steam offers the greatest improvement in net carbon reduction. Still, the limited solubility of water in the fuel, the addition of water, and the complexity of a water injection loop for coking mitigation have limited its application in practical vehicle designs.

Another significant problem encountered by vehicles during hypersonic operations is electrical power generation. Because the traditional Brayton cycle-based power generation approaches are impractical (largely due to the extremely high inlet air temperatures), electrical power for onboard subsystems is provided via lithium-ion batteries in most vehicles. These lithium-ion batteries are generally sufficient for only short flights and system loads. During longer flights, the battery-based system frequently fails to provide sufficient power. In some situations, the use of batteries is precluded due to space and weight constraints. Approaches have been previously explored based upon alternative cycle solutions integrated within the vehicle including thermo-electric modules, open/closed Brayton cycles using a circulating coolant, and related approaches.

There remains a need for systems and methods of sufficiently cooling engines while generating electrical power for use onboard and without coking of fuel passages.

### SUMMARY OF THE INVENTION

The present invention overcomes the foregoing problems and other shortcomings, drawbacks, and challenges of managing heat and electrical power generation for hypersonic vehicles. While the invention will be described in connection with certain embodiments, it will be understood that the invention is not limited to these embodiments. To the contrary, this invention includes all alternatives, modifications, and equivalents as may be included within the spirit and scope of the present invention.

According to embodiments of the present invention, a thermal management and power generation system for a hypersonic vehicle includes a fluid supply having a volatile fluid and a fuel supply having an endothermic fuel. A first heat exchanger, fluidically coupled to the fluid supply, absorbs heat from a first portion of the hypersonic vehicle, which vaporizes the volatile fluid. A mixing apparatus, fluidically coupled to the first heat exchanger and the fuel supply combines the vaporized volatile fuel and endothermic fuel. A second heat exchanger, fluidically coupled to the mixing apparatus, absorbs heat from a second portion of the hypersonic vehicle and decomposes the endothermic fuel by endothermic pyrolysis. A heat engine, fluidically coupled to the first heat exchanger and the mixing apparatus, is configured to generate an electrical power for use by the hypersonic vehicle. The vaporized volatile fluid mixed with the endothermic fuel within the second heat exchanger reduces coking caused by the endothermic pyrolytic decomposition of the endothermic fuel as compared to an endothermic pyrolytic decomposition of an endothermic fuel not having a vaporized volatile fluid mixed therewith.

Another embodiment of the present invention is directed to a method of simultaneously cooling and generating electrical power for use by a hypersonic vehicle and includes absorbing heat form a first portion of the hypersonic vehicle by vaporizing a volatile fluid. Electrical power is generated by a heat engine with the vaporized volatile fluid. An exhaust of the heat engine is mixed with an endothermic fuel. Heat from a second portion of the hypersonic vehicle is absorbed by endothermic pyrolytic decomposition of the endothermic fuel.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A is a partial, cross-sectional view of an exemplary hypersonic vehicle having a thermal management and power generation system according to an embodiment of the present invention.

FIG. 1B is an expanded, cross-sectional view of the thermal management and power generation system of FIG. 1A.

FIG. 2A is a partial, cross-sectional view of an exemplary hypersonic vehicle having a thermal management and power generation system according to another embodiment of the present invention.

FIG. 2B is an expanded, cross-sectional view of the thermal management and power generation system of FIG. 2A.

FIG. 3 is a schematic, cross-sectional view of the thermal management and power generation system of FIG. 1B.

FIG. 4 is a flowchart illustrating a method of thermal management and power generation system according to an embodiment of the present invention.

FIG. 5 is a cross-sectional view of a porous material for use in coolant channels of a heat exchanger in accordance with an embodiment of the present invention.

FIG. 6 is an isometric, partial cross-sectional view of a thermal management and power generation system according to another embodiment of the present invention.

FIG. 7 is a schematic representation of an exemplary thermal management and power generation system according to an embodiment of the present invention.

FIG. 8 is a schematic illustrating results from computer modeling of a thermal management and power generation system according to an embodiment of the present invention.

FIG. 8A is a graphic representation of results from computer modeling of the thermal management and power generation system of FIG. 7.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

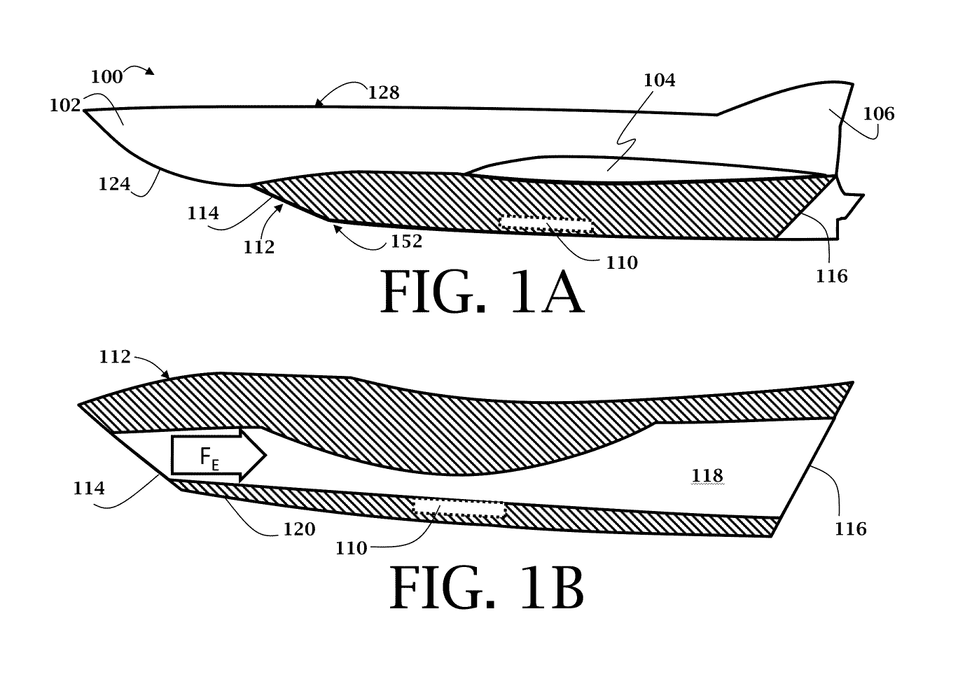

Referring now to the figures, and in particular to FIGS. 1A and 1B, a partial cross-sectional view of an exemplary hypersonic vehicle 100 is shown and includes, generally, a fuselage 102, wings 104 (although only one wing 104 is shown in FIG. 1A), and a tail assembly 106. In one embodiment of present invention, a thermal management and power generation system 110 may be located beneath the fuselage 102 and within an engine assembly 112, which is shown in more detail in FIG. 1B.

As shown in the expanded, cross-sectional view of FIG. 1B, the engine assembly 112 generally comprises an inlet 114, an outlet 116, and a flow channel 118 extending there between. Hypersonic flow is travels within the flow channel 118 in a direction, which is indicated by an arrow F_{E}. While not shown, a propulsion system may be included within the engine assembly 112 and may comprise one or more known systems, including, for example, a conventional gas turbine engine and a supersonic propulsion system (such as a ramjet or scramjet).

FIG. 1B further illustrates the thermal management and power generation system 110, which is located between the flow channel 118 and an internal vehicle surface 120.

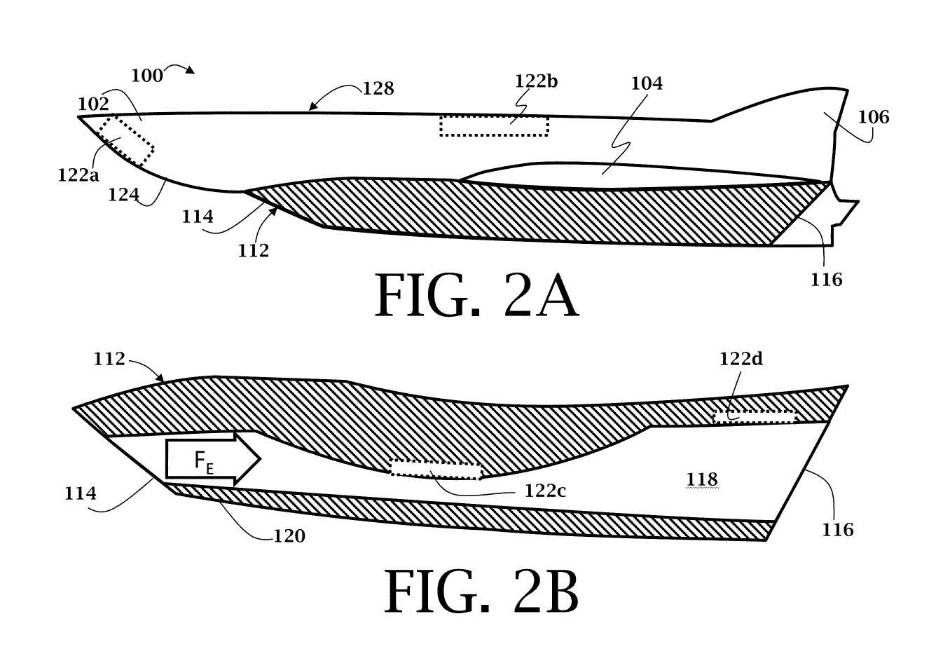

Briefly, and as shown in FIGS. 2A and 2B, alternate embodiments of the vehicle 100 are shown and having a thermal management and power generation system 122a, 122b, 122c, 122d positioned at other locations within the hypersonic vehicle 100. For example, the thermal management and power generation system 122a may be positioned within a channel (not shown) on a leading edge 124 of the fuselage 102; the thermal management and power generation system 122b may, alternatively, be proximate a top surface 128 of the fuselage 102, as shown in FIG. 2A. According to still other examples, the thermal management and power generation system 122c may be positioned above the flow channel 118 and proximate the front edge 124 (FIG. 2A) of the fuselage 102; or the thermal management and power generation system 122d may be proximate above the flow channel 118 and proximate the outlet 116. The embodiments of FIG. 2B may provide a cooling advantage to sources of waste heat (such as, engine heating, avionics heating, onboard electronic system heating, or hydraulic system heating). More generally, the thermal management and power generation system 110, 122a, 122b, 122c, 122d may be positioned at any location within the vehicle 100 that experiences a thermal gradient generated by environmental or engine heating.

One skilled in the art having the advantage of this disclosure would understand that the thermal management and power generation system 110 or components thereof may be positioned at still other suitable locations in the hypersonic vehicle 100, as desired or appropriate. In particular, the thermal management and power generation system may be positioned such that it encircles one or more portions of the hypersonic vehicle 100. Additionally, it would be understood from this disclosure that a plurality of thermal management and power generation systems 110 may be associated with a single hypersonic vehicle 100, wherein each thermal management and power generation system 110 may comprise multiples of a single component, such as the first heat exchanger, the turbine, or the generator.

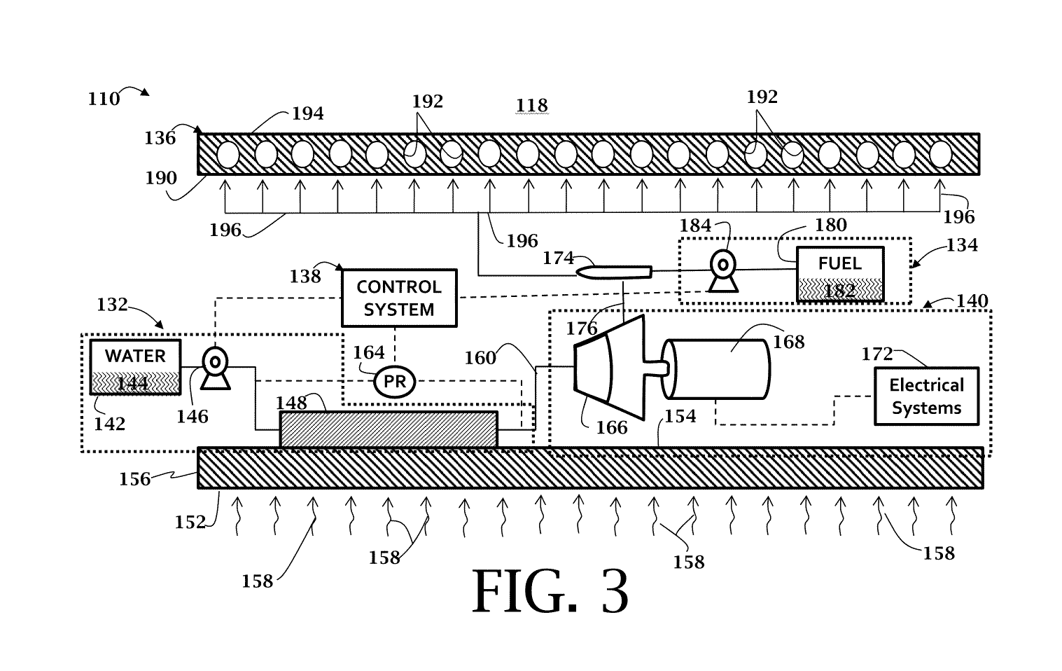

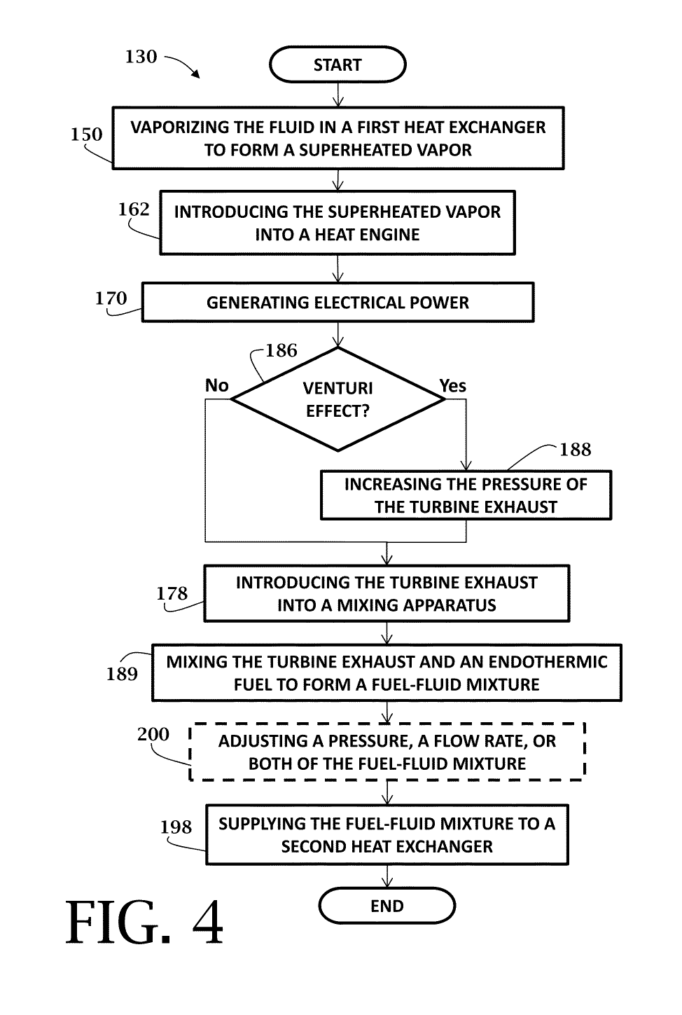

With reference now to FIGS. 3 and 4, an embodiment of the thermal management and power generation system 110 of FIG. 1B and a method 130 of using the same are described with greater detail. As shown, the thermal management and power generation system 110 includes a fluid supply system 132, a fuel supply system 134, a cooling network 136, a control system 138, and a power generation system 140, which are discussed in greater detail below.

The fluid supply system 132 includes comprises a fluid supply 142 having a fluid 144 therein and a pump 146 fluidically coupled to the fluid supply 144 and configured to draw fluid 144 from the fluid supply 142. Although not specifically shown, the skilled artisan would readily appreciate that the fluid supply 142 may actually include a plurality of containers. Generally, the fluid 144 may include any liquid or gas that is volatile, compressible, or configured to vaporize or expand. According to some embodiments, the fluid 144 may be water, an alcohol (such as ethanol), other such fluids, and mixtures thereof, wherein the fluids are miscible.

Fluid 144 drawn from the fluid supply 142 via the 146 pump is directed into a first heat exchanger 148, which may be operable as an evaporator. Examples of suitable evaporators include those having plate/fin configurations, plate/shell configurations, or other suitable alternatives. The evaporator 148 may be constructed from any suitable, thermally-conductive material, including, for example, stainless steel, nickel alloys, carbon, or a hybrid material and is configured to vaporize the fluid to form a superheated vapor, such as by using at least one type of heat load created by the hypersonic vehicle 100 (FIG. 1) during vehicle flight (Block 150). The at least one type of heat load may include aerodynamic heating, engine heating, electronic systems heating, or combinations thereof. More particularly, and in accordance with one embodiment of the present invention, external surfaces 152 of the hypersonic vehicle 100 (FIG. 1) may be exposed to the atmosphere and large amount of aerodynamic heating. The exposures generate a thermal gradient along a length of the hypersonic vehicle 100 (FIG. 1) at the external surfaces 152. Accordingly, the first heat exchanger 148 may be positioned adjacent to, in contact with, or both an surface 154 of a wall 156 that opposes the external surface 152 and so as to take advantage of aerodynamic heating (normally considered waste heat). Such placement exposes the first heat exchanger 148 to heat (illustrated as squiggle lines 158 at the external surface 152), which may vaporize the fluid 144 within the first heat exchanger 148 and, thereby, form the superheated vapor.

As to the alternative embodiments of FIGS. 2A and 2B, although not specifically illustrated therein, the respective first heat exchanges could be integrated into other external vehicle surfaces, other areas, or other component of the hypersonic vehicle 100.

Referring again to FIGS. 3 and 4, the superheated vapor within the first heat exchanger 148, having high temperature and pressure, exits the first heat exchanger 148 via a conduit 160 fluidically coupling the first heat exchanger 148 to the power generation system 140, which, according to an embodiment of the present invention, may be a heat engine (Block 162), which according to some embodiments of the present invention, may be an open Rankine cycle-based system. The conduit 160 may comprise a variety of piping, ducting, tubing, and/or other similar materials with suitable dimensions and properties sufficient to withstand fluids of high temperatures and high pressures. A pressure regulator 164 (illustrated herein as “PR”), or other suitable component, may be used to monitor changes in pressure, amount, or both of superheated vapor within the first heat exchanger 148 and entering a turbine 166 of the power generation system 140. In that regard, the pressure regulator 154 may also be operably coupled to other suitable portions of the thermal management and power generation system 110 via one or more regulator control lines (illustrated in FIG. 3 as dashed lines). For example, the fluid pump 146 and portions of the conduit 160.

The superheated vapor enters the turbine 166 and undergoes expansion, which drives the turbine 166. Although not required, one particular embodiment of the present invention may include an aerospace-grade expansion turbine. The turbine 166, in turn, is operably coupled to a generator 168 such that work accomplished by expansion of the superheated vapor in driving the turbine 166 may be converted to electrical power by the generator 168 (Block 170). The generator 156 may be, for example, a permanent magnet generator, may be coupled to one or more onboard electrical systems 172 requiring electrical power, including but not limited to, an avionics system, electronic systems, hydraulic systems, or the control system 138. According to other embodiments of the present invention, the generator 168 may also or alternatively be coupled to one or more components of the thermal management and power generation system 110, such as the fluid pump 146 or the pressure regulator 164.

Referring still to FIGS. 3 and 4, a turbine exhaust, which may comprise a mixture of two phases of the fluid 144 (i.e., gas (vapor) and condensed liquid) flows out from the turbine 166 and is supplied to a mixing apparatus 174 via an exhaust channel 176 (Block 178). The mixing apparatus 174 is further coupled to the fuel supply system 134, particularly a fuel supply 180 by way of a boost pump 184 and having a fuel 182 therein. The fuel 182 within the fuel supply 180 may be one or more suitable endothermic fuels. The boost pump 184 is configured to draw fuel 182 from the fuel supply 180 (which may, actually, include a plurality of storage tanks) into the mixing apparatus 174, thereby increasing a discharge pressure of the fuel 182 prior to it entering the mixing apparatus 174. According to some embodiments of the present invention, and if desired, the fuel supply 180 may also be fluidically coupled to other systems of the hypersonic vehicle 100 (FIG. 1A), which may, in turn, be coupled to the mixing apparatus 174. In this embodiment, and while the fuel 182 flows to the other systems of the hypersonic vehicle 100 (FIG. 1A), the fuel 182 endothermically decomposes, which may provide a cooling effect to those systems of the hypersonic vehicle 100 (FIG. 1A), as described in greater detail below.

Within the mixing apparatus 184, the fuel 182 and the turbine exhaust (entering the mixing apparatus 174 via the exhaust channel 176 as described above) are combined into a fuel-fluid mixture (Block 186). At times, the pressure of the turbine exhaust is significantly lower than the pressure of the fuel 182 drawn from the fuel supply 180, which may create a Venturi effect (Decision Block 186). If so (“Yes” branch of Decision Block 186), then the mixing apparatus 174 may comprise an ejector pump configured to generate a vacuum, which pulls the turbine exhaust into the ejector pump and, in effect, increases the pressure of the turbine exhaust (Block 188). According to still other embodiments, boost pumps may be positioned along the exhaust channel 176 and may be configured to boost the pressure of the turbine exhaust. According to some embodiments, it may be advantageous to alter the pressure of turbine exhaust to be similar to the pressure of the fuel 182 drawn from the fuel supply 180.

In other embodiments, the mixing apparatus 174 may include heat exchangers (not shown). The heat exchanger, operable as a condenser, may have a plate/fin configuration, a plate/shell configuration, a microchannel configuration, or other suitable configuration. Use of heat exchangers may also benefit from the addition of boost pumps, such as along the exhaust channel 176 to increase the pressure of the turbine exhaust, as was described above.

As would be understood by those skilled in the art having the benefit of the disclosure made herein, by incorporating fluid 144 into the fuel-fluid mixture, coking, which occurs in conventional systems using endothermic decomposition and pyrolysis of fuel, in the fuel channels may be prevented or mitigated. As such, carbon-steam gasification may be used, with or without a gasification catalyst, such as an alkali metal salt

Referring now to FIGS. 1A, 1B, 3, and 4, and with mixing of the fuel 182 and the turbine exhaust is complete (Block 186), the fuel-fluid mixture flows from the mixing apparatus 174 to a second heat exchanger 190 of the cooling network 136 (Block 198). The second heat exchanger 190 includes a plurality of coolant channels 192 and, according to some embodiments of the present invention, may define a bottom surface 194 of the flow channel 118. Accordingly, the fuel-fluid mixture exits the mixing apparatus 174 and is distributed to the plurality of coolant channels 192 via a conduit network 196. Once within the plurality of coolant channels 192 of the second heat exchanger 190, the fuel portion of the fuel-fluid mixture endothermically decomposes, thereby, cooling walls comprising the coolant channels 192 and drawing heat from nearby components of the hypersonic vehicle 100. The at least partially decomposed fuel-fluid mixture is exhausted from the coolant channels 192 into the flow channel 118 where any remaining portion of the fuel component of the fuel-fluid mixture may be burned with atmospheric oxygen.

Optionally, a pressure, a flow rate, or both of the fuel-fluid mixture may be adjusted prior to supplying the fuel-fluid mixture to the conduit network 196 and plurality of coolant channels 192 (Block 200) so as to meet the desired cooling requirements of the hypersonic vehicle 100 and/or to be compatible with the tolerances of downstream components. Increasing the pressure of the fuel-fluid mixture may include one or more boost pumps, fluid pumps, pressure regulators, and so forth (not shown). Additionally or alternatively, one or more boost pumps, fluid pumps, pressure regulators, and so forth (not shown) may be used to increase a pressure, a flow rate, or both of the fuel-fluid mixture as its exhausts into the flow channel 118.

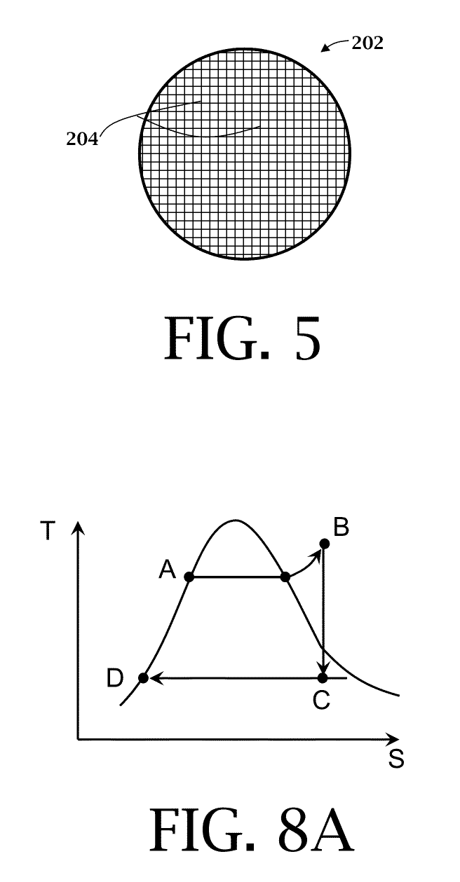

Referring now to FIGS. 4 and 5, an apparatus for reducing or preventing coking according to another embodiment of the present invention is shown. In that regard, coking may be reduced or eliminated by promoting selective pyrolysis reactions, i.e., heterogeneous catalytic pyrolysis reactions. To that end, each coolant channel 192 may include a porous material 202 therein. The porous material 202 includes a cellular mesh 204 defining a plurality of pores of substantially uniform size. Suitable porous materials 202 may include, for example, a monolith or other suitable support, including a porous mesh, a sponge, or a sintered metal-based support. The porous material 202 may be constructed of carbon, silicon carbide (SiC), an inert metal, or other suitable, thermally-conductive substrate materials. In some embodiments, the porous material 202 may, optionally, be functionalized or doped with one or more catalyst materials, including zeolites, metal oxides, or other suitable compounds that act to chemically-enhance pyrolysis. The plurality of pores defined by the cellular mesh 204 increases a surface area of the porous material 202, which improves uniformity of temperature and promotes greater selectivity in the pyrolysis reactions, which reduces coking.

With reference to FIG. 3, the control system 138 of the thermal management and power generation system 110 may include one or more computers, sensors, controllers, and other components configured to measure, monitor, and control the operation of the thermal management and power generation system 110. The control system 136 may be operably coupled to various components via several control lines (illustrated in FIG. 3 as dashed lines). For example, the control system 138 may be coupled to the fluid pump 146, the pressure relief 164, or both so as to monitor and regulate the amount of superheated vapor entering the turbine 166. Such monitoring and regulating may be accomplished, for example, via a series of valves or other suitable flow-control components, which would be readily understood by those of ordinary skill in the art having the benefit of the disclosure herein, although not specifically illustrated. The control system 138 may additionally or alternatively be coupled to the mixing apparatus 174, the boost pump 184, or both to control the amount and rate of turbine exhaust, fuel 182, or both into the mixing apparatus 174. Accordingly, a fuel-to-fluid ratio may be manipulated via valves or other suitable flow-control components. Those skilled in the art will understand that the thermal management and power generation system 110 and the control system 138 may each comprise additional components, which are not shown or separately labeled in FIG. 3 and which may be required or are desirable for optimal performance and operation, including, but not limited to, additional valves, sensors, control lines, and conduits. Moreover, the control system 138 may comprise one or more control systems 138, each having operable control over one or more systems of the thermal management and power generation system 110.

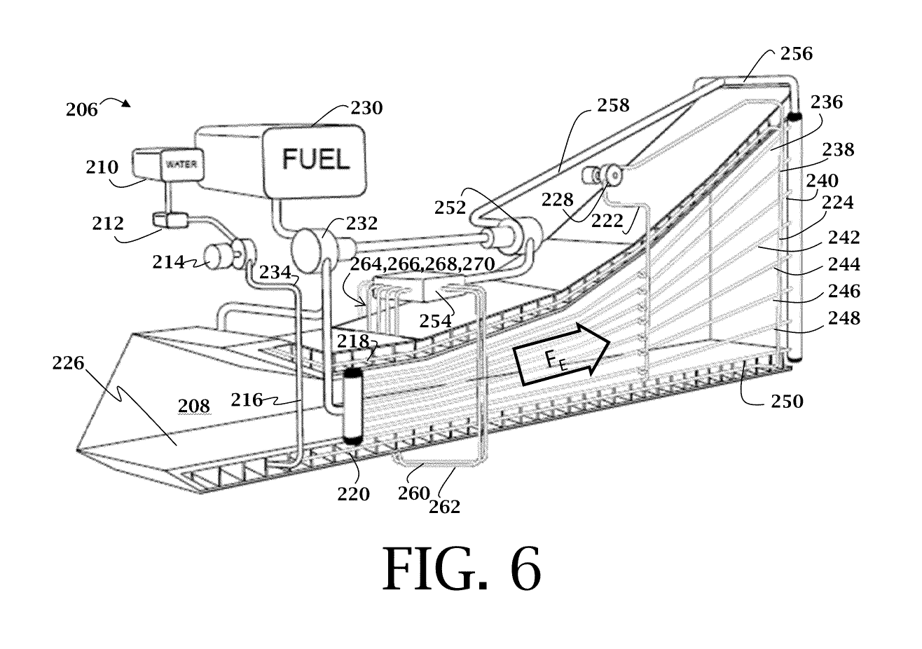

Turning now to FIG. 6, another exemplary embodiment of a thermal management and power generation system 206 is shown in partial cross-section. The thermal management and power generation system 206 may be positioned proximate an engine flowpath 208, such as would be found in the hypersonic vehicle 100 (FIG. 1A), but could alternatively be positioned proximate any portion of the hypersonic vehicle 100 (FIG. 1A) that requires cooling. More than one system 206 per hypersonic vehicle 100 (FIG. 1A) may be used.

The thermal management and power generation system 206 includes a volatile fluid supply (illustrated as a water supply 210), the flow of which is controlled by a manifold 212 and a water pump 214. As such, water is drawn from the water supply 210 into a series of water conduits 216, 218, 220, 222, 224.

In FIG. 6, the water may circulate along several pathways through the water conduits 216, 218, 220, 222, 224, some of which may be proximate, adjacent, or within an external surface (for example, external surface 152 of FIG. 1A) of the hypersonic vehicle 100 (FIG. 1A), an internal surface (for example, a bottom surface 226 of the engine flowpath 208), or both. Additionally, or alternatively, at least a portion of the water conduits 216, 218 may be directed to a plurality of cooling channels 221, 223 within top and bottom walls 225, 227 of the engine flowpath 208 (or other walls, although not specifically shown). Each pathway is proximate an area or system of the hypersonic vehicle 100 (FIG. 1A) having extreme thermal gradients, requiring cooling, or both. Water within the water conduits 216 along these pathways absorbs the excess heat and is thereby heated and vaporized to steam. The steam is then transported to a turbo-expander 228.

The thermal management and power generation system 206 further includes an endothermic fuel supply 230 and a fuel pump 232 to draw the endothermic fuel from the supply 230 and into fuel conduits 234, 236, 238, 240, 242, 244, 246, 248, 250, 256, 258. Fuel within the fuel conduits 234, 236, 238, 240, 242, 244, 246, 248, 250, 256, 258 may be used to cool sidewalls (not shown) of the engine flowpath 208 and/or be routed to any portion of the hypersonic vehicle 100 (FIG. 1A) that experiences a thermal gradient.

Steam, as from the turbo expander 228 may be mixed with heated fuel from fuel conduits 234, 236, 238, 240, 242, 244, 246, 248, 250, 256, 258 to yield a fuel-fluid mixture. A boost pump 252 may be used to receive the fuel-fluid mixture and direct the fuel-fluid mixture to a fuel injector 254, which may be controlled by a series of valves (not shown). The fuel-fluid mixture at the fuel injector 254 is then injected into a series of conduits 260, 262, 264, 266, 268, 270, wherein the fuel component of the fuel-fluid mixture is burned with atmospheric oxygen of air within the engine flowpath 208.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### EXAMPLE 1

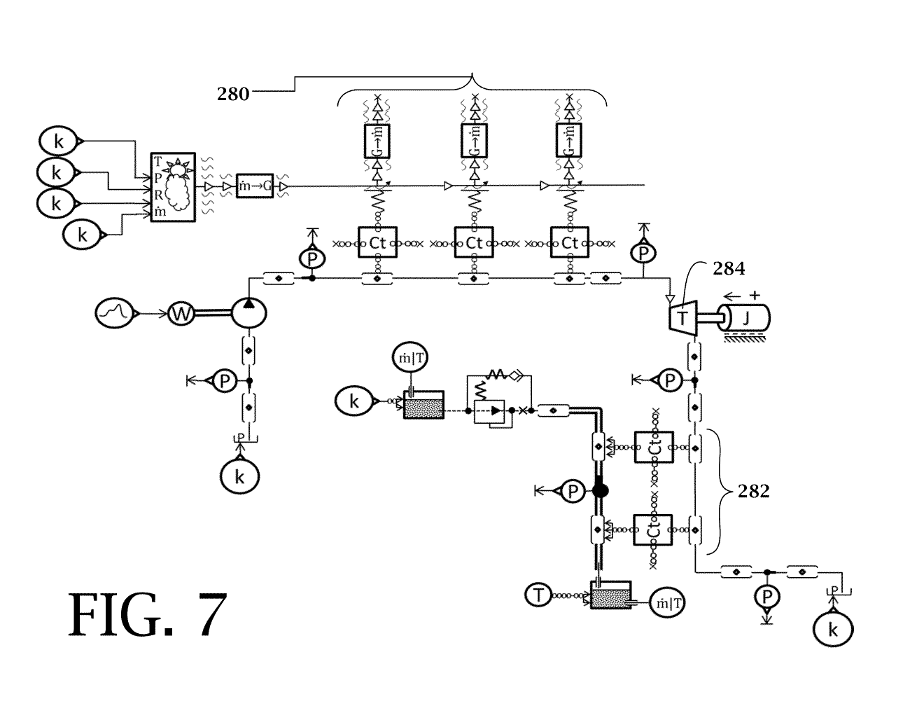

FIG. 7 is a schematic representation of a thermal management and power generation system according to an embodiment of the present invention, modeled using AMESim software (LMS Imagine.Lab®, LMS® International). The modeled thermal management generation system includes a first heat exchanger 280, a second heat exchanger 282, and a turbine 284. Conduits for water are illustrated as solid lines; conduits for fuel are illustrated as dashed lines.

### EXAMPLE 2

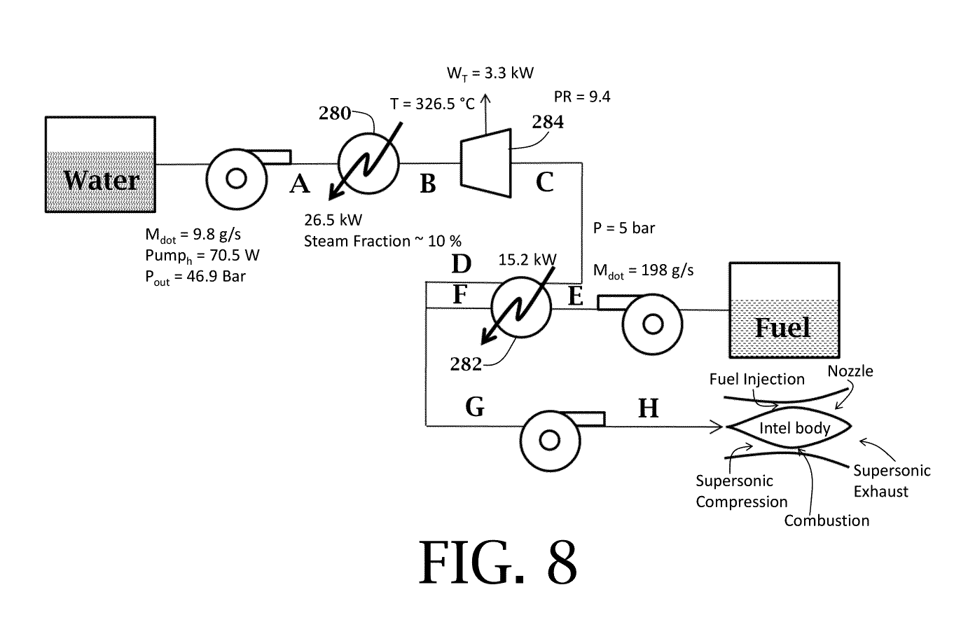

FIG. 8 is a schematic illustrating results of modeling of the thermal management and power generation system of Example 1. Calculations were performed on AMESim software with units per 1000 lbs thrust and assuming about 5 steam wt %. As shown in FIG. 8, aerodynamic and/or vehicle system heating vaporizes the water, absorbing a heat load of approximately 25.4 kW to generate steam, which enters the turbine. The heat engine of the thermal management and power generation system can then be expected to generate over 3 kW of power for use onboard the vehicle. The endothermic fuel may also be used to cool the vehicle, absorbing a heat load of about 19 kW.

The present invention comprises a combined thermal management and power generation system and methods for using the same. An exemplary system may incorporate a heat engine fluid power generation system into an endothermic fuel cooling system. The presently disclosed system may be particularly useful for high supersonic and hypersonic vehicles because these vehicles generate aerodynamic heat during flight in addition to heat generated by operational systems and sub-systems, including onboard electronics and avionics. The thermal management and power generation system, according to embodiments herein, may provide a number of platform-level benefits, including additional platform cooling and power generation that is not limited by the high inlet air temperatures associated with hypersonic flight. Further, and according to some embodiments of the present invention, when turbine exhaust is fed into the fuel stream prior to endothermic pyrolytic decomposition, coke deposition rates may be reduced considerably, with a concomitant heat of combustion upgrade in the partially reformed fuel effluent. Additionally still, the various embodiments of the present invention described herein provide better control of the combustion fuel composition as favorable decomposition products (for example, ethylene) may be enhanced over less favorable decomposition products (for example, acetylene) via proper catalyst and volatile fluid selection.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

1. A thermal management and power generation system for a hypersonic vehicle comprising:
a fluid supply comprising a volatile fluid;
a fuel supply comprising an endothermic fuel;
a first heat exchanger in fluidic communication with the fluid supply and configured to absorb heat from a first portion of the hypersonic vehicle and vaporize the volatile fluid;
a mixing apparatus in fluidic communication with the first heat exchanger and the fuel supply and configured to combine the vaporized volatile fluid from the first heat exchanger with the endothermic fuel from the fuel supply;
a heat engine in fluidic communication with the first heat exchanger and the mixing apparatus, the heat engine configured to generate an electrical power for use by the hypersonic vehicle; and
a second heat exchanger in fluidic communication with the mixing apparatus and configured to absorb heat from a second portion of the hypersonic vehicle and decompose, by endothermic pyrolysis, the volatile fuel,
wherein the vaporized volatile fluid reduces coking caused by the endothermic pyrolytic decomposition of the endothermic fuel as compared to an endothermic pyrolytic decomposition of an endothermic fuel not having a vaporized volatile fluid mixed therewith.

2. The thermal management and power generation system of claim 1, further comprising:
a control system configured to control at least one of the fluid supply, the fuel supply, the first heat exchanger, the second heat exchanger, the heat engine, an avionics system, a hydraulic system, and an electronic system.

3. The thermal management and power generation system of claim 1, wherein an exhaust of the heat engine comprises the vaporized volatile fluid received by the mixing apparatus.

4. The thermal management and power generation system of claim 3, further comprising:
a boost pump fluidically coupled between the heat engine and configured to increase a pressure of the exhaust before the exhaust is received by the mixing apparatus.

5. The thermal management and power generation system of claim 3, wherein the heat engine further comprises:
a turbine; and
a generator.

6. The thermal management and power generation system of claim 5, wherein the turbine is selected from the group consisting of a gas turbine, and an aerospace-grade expansion turbine.

7. The thermal management and power generation system of claim 5, wherein the generator is a permanent magnet generator.

8. The thermal management and power generation system of claim 1, wherein the volatile fluid supply further comprises a fluid pump.

9. The thermal management and power generation system of claim 1, wherein the fuel supply further comprises a fuel pump.

10. The thermal management and power generation system of claim 1, wherein the volatile fluid is selected from the group consisting of water and an alcohol.

11. The thermal management and power generation system of claim 1, wherein the endothermic fuel is a cryogenic fuel.

12. The thermal management and power generation system of claim 1, wherein the second heat exchanger further comprises:
a plurality of coolant channels configured to distribute the combined vaporized volatile fluid and endothermic fuel throughout the second heat exchanger.

13. The thermal management and power generation system of claim 12, wherein each coolant channel of the plurality includes a porous material configured to increase a surface area of each coolant channel of the plurality and thereby further reduce coking.

14. The thermal management and power generation system of claim 13, wherein the porous material comprising carbon, silicon carbide, a sponge, a sintered metal, and an inert metal.

15. The thermal management and power generation system of claim 14, wherein the porous material includes at least one catalyst configured to chemically-enhance pyrolysis.

16. The thermal management and power generation system of claim 15, wherein the at least one catalyst is selected from the group consisting of zeolites and metal oxides.

17. The thermal management and power generation system of claim 1, wherein the mixing apparatus is an ejector pump.

18. The thermal management and power generation system of claim 1, further comprising:
a third heat exchanger comprising the mixing apparatus.

19. The thermal management and power generation system of claim 1, further comprising:
a boost pump fluidically coupled between the mixing apparatus and the second heat exchanger, the boost pump configured to increase a pressure of the combined vaporized volatile fluid and endothermic fuel.

20-25. (canceled)
